(19) United States
(12) Patent Application Publication
(10) Pub. No.: US 2026/0261198 A1
(43) Pub. Date: Sep. 3, 2026

(54) ADAPTIVE FAULT-TOLERANT TOPOLOGY FOR THREE-PHASE MULTI-PARALLEL CONVERTER BASED ON REDUNDANT UNITS

(71) Applicant: NANJING UNIVERSITY OF SCIENCE AND TECHNOLOGY, Nanjing (CN)

(72) Inventors: Zhiyong ZENG, Nanjing (CN); Xiaoliang JIN, Nanjing (CN); Chong ZHU, Nanjing (CN); Lei LI, Nanjing (CN)

(21) Appl. No.: 19/472,273

(22) PCT Filed: Sep. 23, 2024
(86) PCT No.: PCT/CN2024/120356

§ 371 Date: Oct. 3, 2025

(30) Foreign Application Priority Data
Nov. 23, 2023 (CN) 202311583485.7

(51) Int. Cl. H02M 1/32; H02M 7/5387

(52) U.S. Cl. CPC H02M 1/325; H02M 7/53871

(57) ABSTRACT

An adaptive fault-tolerant topology for a three-phase multi-parallel converter based on redundant units is disclosed, wherein a redundant module of each phase is connected to a parallel branch through redundant diodes; during normal operation, the redundant module is maintained in an off state and not connected to the parallel branch, when an open-circuit fault occurs in an IGBT or diode of the parallel bridge arm, the redundant module is automatically connected to the parallel branch through the redundant diodes, replacing faulty components in the parallel bridge arm, allowing the multi-parallel converter to operate normally. This disclosure does not require additional control circuits. It can flexibly configure diodes and redundant units according to various fault types to meet the actual reliability requirements achieving adaptive reconfiguration of hardware resources. Meanwhile, through fault-tolerant control algorithms, this disclosure enables fault-tolerant operation of the topology when a fault occurs.

### CROSS-REFERENCE TO RELATED APPLICATIONS

The disclosure is based upon and claims priority to Chinese Patent Application No. 202311583485.7, filed on Nov. 23, 2023, titled “Adaptive Fault-Tolerant Topology for a Three-Phase Multi-Parallel Converter Based on Redundant Units”, the entire contents of which are incorporated herein by reference.

### TECHNICAL FIELD

The disclosure relates to multi-parallel converters, and in particular to an adaptive fault-tolerant topology for a three-phase multi-parallel converter based on redundant units.

### BACKGROUND

The uninterrupted continuous operation capability of low-speed high-torque direct-drive devices is a fundamental requirement and a practical demand for the large-scale promotion of industrial production. For example, to ensure uninterrupted coal production, coal mine scraper conveyors must have high reliability and strong fault-tolerant operation capability. The reliability of low-speed high-torque direct-drive devices depends on both electrical equipment and mechanical equipment. Among them, in terms of electrical aspects, multi-parallel converters are a relatively weak link. Therefore, the highly reliable operation of multi-parallel converters is an important guarantee for the successful promotion of low-speed high-torque direct-drive devices. Industrial field statistics show that power semiconductor switching transistors are the most vulnerable components in the converter, and most converter failures are related to semiconductor device failures. Typically, research on fault tolerance of converters is divided into three aspects: fault diagnosis, fault topology reconfiguration, and fault-tolerant control algorithms. These three aspects of research are interconnected and indispensable. Meanwhile, the latter two aspects complement each other. However, existing literature only focuses on the research of fault diagnosis, lacking the research on fault topology reconfiguration and fault-tolerant control. For multi-parallel converters, when a fault occurs, it is common to reduce the operating capacity by disconnecting the converter where the fault source is located.

However, in some critical production conditions, operating at a reduced rating may lead to secondary failures of the equipment. For example, the rated power of a coal mining machine and a coal mine scraper conveyor are matched, and when the scraper conveyor operates at a reduced rating, the load (raw coal and gangue) will exceed the output power of the scraper conveyor, which will result in a decrease in motor speed, causing compression of the raw coal and gangue, which could easily lead to safety accidents. In extreme cases, it may lead to motor stalling, damaging the remaining power semiconductor devices, and causing secondary failures in the transmission system. Compared with the extensive research on fault tolerance in other high-power topologies, research on fault-tolerant topology reconfiguration and fault-tolerant control for multi-parallel converters remains unexplored in both domestic and international academia. Moreover, due to differences in topology and operational characteristics, fault-tolerant topology reconfiguration and fault-tolerant control techniques used in other high-power converters cannot be directly applied to multi-parallel converters. Therefore, considering the practical demand for the highly reliable operation of multi-parallel converters in industrial production, it is imperative to study fault-tolerant topology reconfiguration and fault-tolerant control strategies for multi-parallel converters, thereby providing core support technology for the large-scale promotion of low-speed high-torque direct-drive devices.

### SUMMARY

The disclosure provides an adaptive fault-tolerant topology for a three-phase multi-parallel converter based on redundant units, which minimizes the impact of open-circuit faults on the multi-parallel converter system, achieves fault-tolerant functionality, and improves the reliability of the multi-parallel converter system.

The disclosure provides an adaptive fault-tolerant topology for a three-phase multi-parallel converter based on redundant units, including a DC power supply, a three-phase AC power supply or a three-phase load resistor, three-phase filter inductors, and three-phase parallel branches, the parallel branches of each phase including n parallel bridge arms and n parallel filter inductors, each phase further includes a redundant module including redundant units and redundant diodes, each redundant unit is a combination of IGBTs and diodes, the redundant unit is connected to an AC output side of the corresponding parallel bridge arms through a redundant diode; during normal operation, the redundant module is maintained in an off state and not connected to the parallel branch, when an open-circuit fault occurs in an IGBT (switching transistor) or diode of the parallel bridge arm, the redundant unit is automatically connected to the faulty branch through the redundant diode, replacing faulty components in the faulty bridge arm, ensuring the multi-parallel converter operates normally.

Selectively, each phase redundant module includes an upper-arm redundant module and a lower-arm redundant module. The upper-arm redundant module includes upper-arm redundant units and upper-arm redundant diodes, and the lower-arm redundant module includes lower-arm redundant units and lower-arm redundant diodes. The upper-arm redundant module is used for backup in case of upper-arm IGBT fault and lower-arm diode fault in the parallel bridge arm, and the lower-arm redundant module is used for backup in case of lower-arm IGBT fault and upper-arm diode fault in the parallel bridge arm.

Selectively, the upper-arm redundant units and the lower-arm redundant units are connected in parallel with the parallel bridge arms, the emitters of the IGBTs in the upper-arm redundant units are connected to the AC output side of the parallel branch through the upper-arm redundant diodes, and the collectors of the IGBTs in the lower-arm redundant units are connected to the AC output side of the parallel branch through the lower-arm redundant diodes.

Selectively, the upper-arm redundant module in phase x includes p upper-arm redundant units and p_{z}(p_{z}≥p) upper-arm redundant diodes. The redundant connection scheme is as follows: the emitter of the IGBT in the first upper-arm redundant unit is connected to the anodes of p₁(p₁>1) upper-arm redundant diodes, and their cathodes are connected to p₁ different parallel bridge arms in phase x; the emitter of the IGBT in the k-th(1<k<p) upper-arm redundant unit is connected to the anodes of pₖ(1≤pₖ≤n) upper-arm redundant diodes, and their cathodes are connected to pₖ different parallel bridge arms in phase x; and so forth, the emitter of the IGBT in the p-th upper-arm redundant unit is connected to the anodes of pₚ(1≤pₚ≤n) upper-arm redundant diodes, and their cathodes are connected to pₚ different parallel bridge arms in phase x. The scheme provides backup for faults in 1 to max(p,n) upper-arm IGBTs or lower-arm diodes in a single phase, with the parameters satisfying

$${\sum }_{k = 1}^{p} {p}_{k} = {p}_{z} .$$

With n parallel bridge arms, based on permutations and combinations, the number of redundant combination schemes is

$${\prod }_{k = 1}^{p} {C}_{n}^{{p}_{k}} .$$

Selectively, the lower-arm redundant module in phase x includes q lower-arm redundant units and q_{z}(q_{z}≥q) lower-arm redundant diodes. The redundant connection scheme is as follows: the collector of the IGBT in the first lower-arm redundant unit is connected to the cathodes of q₁(n≥q₁≥1) lower-arm redundant diodes, and their anodes are connected to q₁ different parallel bridge arms in phase x; the collector of the IGBT in the k-th(1<k<q) lower-arm redundant unit is connected to the cathodes of qₖ(1≤qx≤n) lower-arm redundant diodes, and their anodes are connected to qₖ different parallel bridge arms in phase x; and so forth, for the q lower-arm redundant units, the collector of the IGBT in the q-th lower-arm redundant unit is connected to the cathodes of q_{q}(1≤q_{q}≤n) lower-arm redundant diodes, and their anodes are connected to q_{q} different parallel bridge arms in phase x. The scheme provides backup for faults in 1 to max(q,n) lower-arm IGBTs or upper-arm diodes in a single phase, with the parameters satisfying

$${\sum }_{k = 1}^{q} {q}_{k} = {q}_{z} .$$

With n parallel bridge arms, based on permutations and combinations, the number of redundant combination schemes is

$${\prod }_{k = 1}^{q} {C}_{n}^{{q}_{k}} .$$

The proposed hardware redundancy scheme does not require additional control circuits. Moreover, for various types of faults, the proposed hardware redundancy scheme can adaptively reconfigure hardware resources through redundant modules and redundant diodes.

Selectively, the upper-arm redundant unit includes four basic topology structures:

Topology 1 includes only one IGBT. Topology 2 includes one IGBT and one diode with the IGBT's emitter connected to the diode's anode and the IGBT's collector connected to the diode's cathode. Topology 3 includes one IGBT and one diode connected in series with the IGBT's emitter connected to the diode's cathode. Topology 4 includes one IGBT and two diodes with an additional diode connected in series based on topology 2 with the IGBT's emitter connected to the cathode of the series-connected diode.

In topology 1 and topology 2, the IGBT's collector is either directly connected to the positive terminal of the DC bus or indirectly connected through a low-impedance element, the IGBT's emitter is connected to the anode of the upper-arm redundant diode, and the cathode of the upper-arm redundant diode is connected to the AC output side of the normal parallel bridge arm. Topology 1 and topology 2 enable topological adaptive reconfiguration following an open-circuit fault in the upper-arm IGBT. In topology 3 and topology 4, the IGBT's collector is either directly connected to the positive terminal of the DC bus or indirectly connected through a low-impedance element, the IGBT's emitter is connected to the anode of the upper-arm redundant diode, the cathode of the upper-arm redundant diode is connected to the AC output side of the normal parallel bridge arm, and the anode of the series-connected diode is connected to the negative terminal of the DC bus. Topology 3 and topology 4 enable topological adaptive reconfiguration following the occurrence of open-circuit faults in both the upper-arm IGBT and the lower-arm diode.

Selectively, the lower-arm redundant unit includes four basic topology structures:

Topology 5 includes only one IGBT. Topology 6 includes one IGBT and one diode with the IGBT's emitter connected to the diode's anode and the IGBT's collector connected to the diode's cathode. Topology 7 includes one IGBT and one diode with the IGBT's collector connected to the diode's anode. Topology 8 includes one IGBT and two diodes with an additional diode connected in series based on topology 6 with the IGBT's collector connected to the anode of the series-connected diode.

In topology 5 and topology 6, the IGBT's emitter is either directly connected to the negative terminal of the DC bus or indirectly connected through a low-impedance element, the IGBT's collector is connected to the cathode of the lower-arm redundant diode, and the anode of the lower-arm redundant diode is connected to the AC output side of the normal parallel bridge arm. Topology 5 and topology 6 enable topological adaptive reconfiguration after an open-circuit fault occurs in the lower-arm IGBT. In topology 7 and topology 8, the IGBT's emitter is directly connected to the negative terminal of the DC bus or indirectly connected through a low-impedance element, the IGBT's collector is connected to the cathode of the lower-arm redundant diode, the anode of the lower-arm redundant diode is connected to the AC output side of the normal parallel bridge arm, and the cathode of the series-connected diode is connected to the positive terminal of the DC bus. Topology 7 and topology 8 enable topological adaptive reconfiguration following the occurrence of open-circuit faults in both the lower-arm IGBT and upper-arm diode of the parallel bridge arm.

Selectively, based on the number of parallel branches n, where n can be any positive integer, the upper-arm redundant units and lower-arm redundant units satisfy the following conditions:

Configured to mitigate simultaneous faults of upper-arm IGBTs across all branches in n parallel converters while maintaining system stability, the number of upper-arm redundant units is set to p≥n, and the number of upper-arm redundant diodes is within the range of [p,pn].

Configured to mitigate simultaneous faults of lower-arm IGBTs across all branches in n parallel converters while maintaining system stability, the number of lower-arm redundant units is set to q≥n, and the number of lower-arm redundant diodes is within the range of [q,qn].

Selectively, the operating conditions of the parallel converter include a normal operating state and a fault-tolerant operating state, specifically as follows:

During normal operation, the redundant module is maintained in an off state and is not connected to the parallel topology, thereby not affecting the normal operating condition.

When an open-circuit fault occurs in the upper-arm IGBT of the k-th parallel branch in phase x, the upper-arm redundant unit (in topology 1 to topology 4) connected in parallel with the k-th branch is activated, and the emitter of the IGBT in the upper-arm redundant unit is automatically connected to the parallel topology through the upper-arm redundant diode, thereby replacing the faulty upper-arm IGBT and achieving reconfiguration of the hardware topology.

When an open-circuit fault occurs in the upper-arm diode of the k-th parallel branch in phase x, the current that originally passes through the faulty diode flows through the lower-arm redundant diode into the series-connected diode of the lower-arm redundant unit (in topology 7 and topology 8) connected in parallel with the faulty bridge arm, thereby achieving reconfiguration of the hardware topology.

When an open-circuit fault occurs in the lower-arm IGBT of the k-th parallel branch in phase x, the lower-arm redundant unit (in topology 5 to topology 8) connected in parallel with the k-th branch is activated, and the collector of the IGBT in the lower-arm redundant unit is automatically connected to the parallel topology through the redundant diode, thereby replacing the faulty lower-arm IGBT and achieving reconfiguration of the hardware topology.

When an open-circuit fault occurs in the lower-arm diode of the k-th parallel branch in phase x, the current that originally passes through the faulty diode flows through the upper-arm redundant diode into the series-connected diode of the upper-arm redundant unit (in topology 3 and topology 4) connected in parallel with the faulty bridge arm, thereby achieving reconfiguration of the hardware topology.

Selectively, the control method of the redundant module is as follows:

During normal operation, the drive signal of the redundant module is maintained at a low level, and the redundant module is maintained in an off state and is not connected to the topology. The normal bridge arm uses a normal operation control strategy to achieve system operation.

When a fault occurs, the drive signal of the redundant module connected in parallel with the faulty phase bridge arm is enabled, the redundant module is automatically connected to the hardware topology through the redundant diode. Simultaneously, the drive signals of all parallel branches of the faulty bridge arm are synchronized with the signal of the redundant module to achieve fault-tolerant operation after the fault. The synchronization signal can be selected from the signal of any bridge arm in the parallel branch.

Compared with the prior art, the disclosure has the following beneficial effects:

The disclosure proposes a fault-tolerant redundant unit connection scheme for open-circuit faults of switching transistors and diodes in multi-parallel converters. The scheme does not require additional control circuits and can adaptively reconfigure hardware resources by flexibly configuring diodes and fault-tolerant redundant units according to various fault types to meet the actual reliability requirements. Moreover, through the fault-tolerant operation algorithm, the disclosure enables fault-tolerant operation of the topology when a fault occurs, providing core support technology for the large-scale promotion of low-speed high-torque direct-drive devices.

### BRIEF DESCRIPTION OF THE DRAWINGS

FIG. 1 is a diagram of an adaptive fault-tolerant topology for a three-phase multi-parallel converter according to the disclosure.

FIG. 2(a) is a diagram of the upper-arm redundant unit including only one IGBT;

FIG. 2(b) is a diagram of the upper-arm redundant unit including one IGBT and one diode;

FIG. 2(c) is a diagram of the upper-arm redundant unit including one IGBT and one diode;

FIG. 2(d) is a diagram of the upper-arm redundant unit including one IGBT and two diodes.

FIG. 3(a) is a diagram of the lower-arm redundant unit including only one IGBT;

FIG. 3(b) is a diagram of the lower-arm redundant unit including one IGBT and one diode;

FIG. 3(c) is a diagram of the lower-arm redundant unit including one IGBT and one diode;

FIG. 3(d) is a diagram of the lower-arm redundant unit including one IGBT and two diodes.

FIG. 4 is a current flow diagram in phase a when the switching state is (S₁₁, S₂₁, S₃₁)=(1,0,1).

FIG. 5 is a current flow diagram in phase a when the switching state is (S₁₁, S₂₁, S₃₁)=(1,1,0).

FIG. 6(a) shows the current path diagram in phase a when the switching signals in phase a are fully synchronized and the parallel current is positive, with the upper-arm IGBT operating normally and outputting a positive voltage level; FIG. 6(b) shows the current path diagram in phase a when the switching signals in phase a are fully synchronized and the parallel current is positive, with a single upper-arm IGBT faulty and outputting a positive voltage level;

FIG. 6(c) shows the current path diagram in phase a when the switching signals in phase a are fully synchronized and the parallel current is positive, with the lower-arm diode operating normally and outputting a negative voltage level; FIG. 6(d) shows the current path diagram in phase a when the switching signals in phase a are fully synchronized and the parallel current is positive, with a single lower-arm diode faulty and outputting a negative voltage level; FIG. 6(e) shows the current path diagram in phase a when the switching signals in phase a are fully synchronized and the parallel current is negative, with the lower-arm IGBT operating normally and outputting a positive voltage level; FIG. 6(f) shows the current path diagram in phase a when the switching signals in phase a are fully synchronized and the parallel current is negative, with a single lower-arm IGBT faulty and outputting a positive voltage level; FIG. 6(g) shows the current path diagram in phase a when the switching signals in phase a are fully synchronized and the parallel current is negative, with the upper-arm diode operating normally and outputting a negative voltage level; FIG. 6(h) shows the current path diagram in phase a when the switching signals in phase a are fully synchronized and the parallel current is negative, with a single upper-arm diode faulty and outputting a negative voltage level.

FIG. 7(a) is a three-phase parallel current waveform diagram from the occurrence of an open-circuit fault in two IGBTs of the first branch in phase b to the adaptive fault-tolerant operation of the converter; FIG. 7(b) is a three-phase current waveform diagram of the first converter from the occurrence of an open-circuit fault in two IGBTs of the first branch in phase b to the adaptive fault-tolerant operation of the converter; FIG. 7(c) is a three-phase current waveform diagram of the second converter from the occurrence of an open-circuit fault in two IGBTs of the first branch in phase b to the adaptive fault-tolerant operation of the converter;

FIG. 7(d) is a three-phase current waveform diagram of the third converter from the occurrence of an open-circuit fault in two IGBTs of the first branch in phase b to the adaptive fault-tolerant operation of the converter.

FIG. 8(a) is the steady-state three-phase parallel current waveform diagram when an open-circuit fault occurs in two IGBTs of the first branch of phase b; FIG. 8(b) is the steady-state three-phase current waveform diagram of the first converter when an open-circuit fault occurs in two IGBTs of the first branch of phase b; FIG. 8(c) is the steady-state three-phase current waveform diagram of the second converter when an open-circuit fault occurs in two IGBTs of the first branch of phase b; FIG. 8(d) is the steady-state three-phase current waveform diagram of the third converter when an open-circuit fault occurs in two IGBTs of the first branch of phase b.

### DETAILED DESCRIPTION

The specific embodiments of the present disclosure will be clearly and fully described in detail below in combination with the drawings. Obviously, the described embodiments are only part of the embodiments of the disclosure and not all of them. Based on the embodiments of the disclosure, all other embodiments obtained by those of ordinary skill in the art without creative efforts shall fall within the scope of protection of the disclosure.

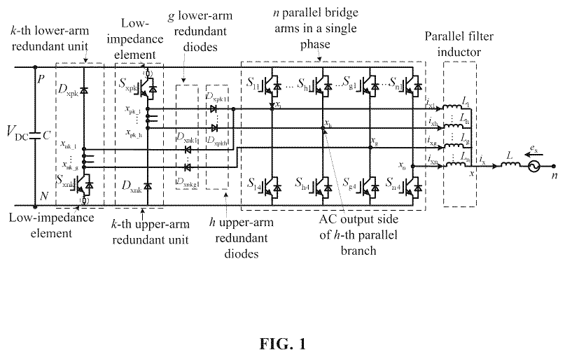

The disclosure proposes a fault-tolerant redundant unit connection scheme for open-circuit faults of IGBTs and diodes in multi-parallel converters. An adaptive fault-tolerant topology for a three-phase multi-parallel converter based on redundant units, as shown in FIG. 1. The adaptive fault-tolerant topology is based on the existing converter topology and further includes a redundant module. When an open-circuit fault occurs in a switching transistor or a diode, the redundant module is adaptively connected to the faulty bridge arm through a redundant diode, providing a current path for the faulty phase bridge arm. The topology minimizes the impact of open-circuit faults on the parallel converter system through hardware reconfiguration, thereby achieving fault-tolerant functionality and improving the reliability of the multi-parallel converter system.

The topology includes a DC power supply, a three-phase AC power supply, three-phase filter inductors, and three-phase parallel branches, the parallel branches of each phase comprising n parallel bridge arms and n parallel filter inductors. Meanwhile, each phase includes an upper-arm redundant module and a lower-arm redundant module. The upper-arm redundant module includes upper-arm redundant units and upper-arm redundant diodes, while the lower-arm redundant module includes lower-arm redundant units and lower-arm redundant diodes. Wherein, the upper-arm redundant units and the lower-arm redundant units are connected in parallel with all parallel bridge arms. The emitters of the IGBTs in the upper-arm redundant units are connected to the AC output side of the parallel branches through the upper-arm redundant diodes, and the collectors of the IGBTs in the lower-arm redundant units are connected to the AC output side of the parallel branches through the lower-arm redundant diodes.

An embodiment of the upper-arm redundant module and the lower-arm redundant module is described in detail as follows:

The upper-arm redundant module in phase a includes p upper-arm redundant units and p_{z}(p_{z}≥p) upper-arm redundant diodes. The redundant connection scheme is as follows: the first upper-arm redundant unit is connected to the anodes of p₁ (p₁≥1) upper-arm redundant diodes, and their cathodes are connected to p₁ different parallel bridge arms in phase a; the k-th upper-arm redundant unit is connected to the anodes of pₖ (pₖ≥1) upper-arm redundant diodes, and their cathodes are connected to pₖ different parallel bridge arms in phase a; and so forth, the p-th upper-arm redundant unit is connected to the anodes of pₚ(pₚ≥1) upper-arm redundant diodes, and their cathodes are connected to pₚ different parallel bridge arms in phase a. The scheme provides backup for faults in 1 to max(p,n) upper-arm IGBTs or lower-arm diodes in a single phase, with the parameters satisfying

$${\sum }_{k = 1}^{p} {p}_{k} = {p}_{z} ,$$

and the number of redundant combination schemes is

$${\prod }_{k = 1}^{p} {C}_{n}^{{p}_{k}} .$$

The lower-arm redundant module in phase a includes q lower-arm redundant units and q_{z}(q_{z}≥q) redundant diodes. The redundant connection scheme is as follows: the collector of the IGBT in the first lower-arm redundant unit is connected to the cathodes of q₁(q₁≥1) lower-arm redundant diodes, and their anodes are connected to q₁ different parallel bridge arms in phase a; the collector of the IGBT in the k-th lower-arm redundant unit is connected to the cathodes of qₖ(qₖ≥1) lower-arm redundant diodes, and their anodes are connected to qₖ different parallel bridge arms in phase a; and so forth, the collector of the IGBT in the q-th lower-arm redundant unit is connected to the cathodes of q_{q}(q_{q}≥1) lower-arm redundant diodes, and their anodes are connected to q_{q} different parallel bridge arms in phase a. The scheme provides backup for faults in 1 to max(q,n) lower-arm IGBTs or upper-arm diodes in a single phase, with the parameters satisfying

$${\sum }_{k = 1}^{q} {q}_{k} = {q}_{z} ,$$

and the number of redundant combination schemes is

$${\prod }_{k = 1}^{q} {C}_{n}^{{q}_{k}} .$$

The proposed hardware redundancy scheme does not require additional control circuits. Moreover, for various types of faults, the proposed hardware redundancy scheme can adaptively reconfigure hardware resources through redundant modules and redundant diodes.

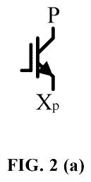

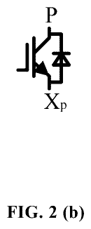

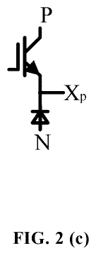

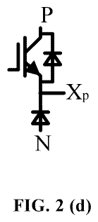

The upper-arm redundant unit includes four structures: Topology 1 includes only one IGBT, as shown in FIG. 2(a). Topology 2 includes one IGBT and one diode with the IGBT's emitter connected to the diode's anode and the IGBT's collector connected to the diode's cathode, as shown in FIG. 2(b). Topology 3 includes one IGBT and one diode with the IGBT's emitter connected to the diode's cathode, as shown in FIG. 2(c). Topology 4 includes one IGBT and two diodes with an additional diode connected in series based on topology 2, with the IGBT's emitter connected to the cathode of the series-connected diode, as shown in FIG. 2(d).

In topology 1 and topology 2, the IGBT's collector is either directly connected to the positive terminal of the DC bus P or indirectly connected through a low-impedance element, the IGBT's emitter Xp is connected to the anode of the upper-arm redundant diode, and the cathode of the upper-arm redundant diode is connected to the AC output side of the normal parallel bridge arm. Topology 1 and topology 2 enable topological adaptive reconfiguration following an open-circuit fault in the upper-arm IGBT. In topology 3 and topology 4, the IGBT's collector is directly connected to the positive terminal of the DC bus P or indirectly connected through a low-impedance element, the IGBT's emitter Xp is connected to the anode of the upper-arm redundant diode, the cathode of the upper-arm redundant diode is connected to the AC output side of the normal parallel bridge arm, and the anode of the series-connected diode is connected to the negative terminal of the DC bus N. Topology 3 and topology 4 enable topological adaptive reconfiguration following the occurrence of open-circuit faults in both the upper-arm IGBT and the lower-arm diode.

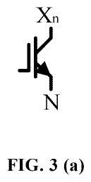

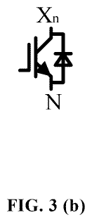

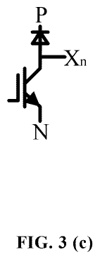

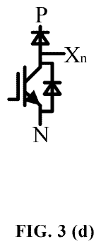

Similarly, the lower-arm redundant unit includes four basic structures: Topology 5 includes only one IGBT, as shown in FIG. 3(a). Topology 6 includes one IGBT and one diode with the IGBT's emitter connected to the diode's anode and the IGBT's collector connected to the diode's cathode, as shown in FIG. 3(b). Topology 7 includes one IGBT and one diode with the IGBT's collector connected to the diode's anode, as shown in FIG. 3(c). Topology 8 includes one IGBT and two diodes with an additional diode connected in series based on topology 6, with the IGBT's collector connected to the anode of the series-connected diode, as shown in FIG. 3(d).

In Topology 5 and Topology 6, the IGBT's emitter is directly connected to the negative terminal N of DC bus or indirectly connected through a low-impedance element, the IGBT's collector Xn is connected to the cathode of the lower-arm redundant diode, and the anode of the lower-arm redundant diode is connected to the AC output side of the normal parallel bridge arm. Topology 5 and topology 6 enable topological adaptive reconfiguration following an open-circuit fault occurs in the lower-arm IGBT. In Topology 7 and topology 8, the IGBT's emitter is directly connected to the negative terminal N of the DC bus or indirectly connected through a low-impedance element, the IGBT's collector Xn is connected to the cathode of the lower-arm redundant diode, the anode of the lower-arm redundant diode is connected to the AC output side of the normal parallel bridge arm, and the cathode of the series-connected diode is connected to the positive terminal P of the DC bus. Topology 7 and topology 8 enable topological adaptive reconfiguration following the occurrence of open-circuit faults in both the lower-arm IGBT and the upper-arm diode.

As an example, the adaptive fault-tolerant topology for a three-phase multi-parallel converter based on redundant units achieves adaptive topology reconfiguration of the multi-parallel converter for open-circuit faults of IGBTs and diodes through the following steps:

The three-parallel converter includes a DC power supply, a three-phase AC power supply and three-phase filter inductors. Meanwhile, each phase includes three parallel branches and a redundant module, which includes one upper-arm redundant unit and one lower-arm redundant unit. As an example, the upper-arm redundant unit in phase a implements the scheme shown in FIG. 2(d), with its AC output side connected to the anodes of three upper-arm redundant diodes, and the cathodes of the upper-arm redundant diodes are respectively connected to the three parallel branches. The lower-arm redundant unit in phase a implements the scheme shown in FIG. 3(d), with its AC output side connected to the cathodes of three lower-arm redundant diodes, and the anodes of the lower-arm redundant diodes are respectively connected to the three parallel branches.

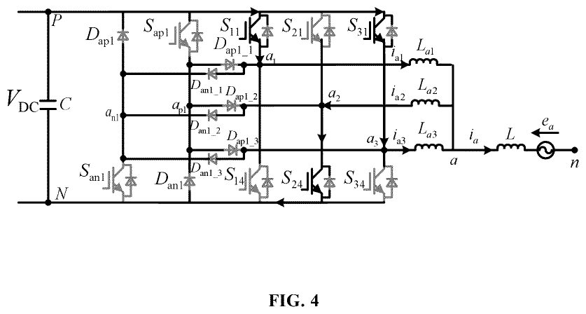

Taking phase a as an example, the positive direction of current flow is defined as from the DC side to the AC side. During normal operation, when the switching state is (S₁₁, S₂₁, S₃₁)=(1, 0, 1), as shown in FIG. 4, S₁₁=1 indicates that the upper-arm switching transistor S₁₁ in the first branch in phase a is on, while the lower-arm switching transistor S₁₄ is off. At this time, the current paths of the three parallel branches are as follows: a) P-S₁₁-a₁-Lₐ₁-a; b) a-Lₐ₂-a₂-S₂₄-N; c) P-S₃₁-a₃-Lₐ₃-a. For the redundant units, their switching states are Sₐₚ₁=Sₐₙ₁=0, indicating that the IGBTs in the redundant module are maintained in the off state, and the redundant bridge arm is not connected to the normal bridge arm, and the system remains in normal operation.

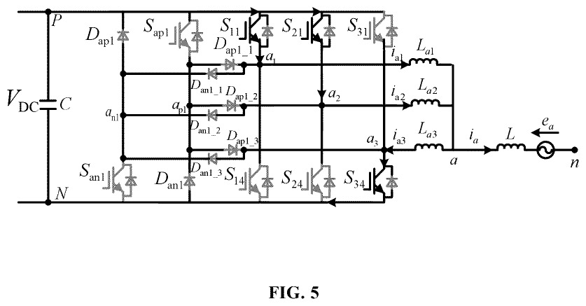

When the switching states are (S₁₁, S₂₁,S₃₁)=(1,1,0), as shown in FIG. 5. At this time, the current paths of the three parallel branches are as follows: a) P-S₁₁-a₁-Lₐ₁-a; b) P-S₂₁-a₂-Lₐ₂-a; c) a-Lₐ₃-a₃-S₃₄-N. Similarly, for the redundant bridge arms, their switching states are Sₐₚ₁=Sₐₙ₁=0, indicating that the IGBTs in the redundant module are maintained in the off state, and the redundant module is not connected to the normal bridge arm, and the system remains in normal operation.

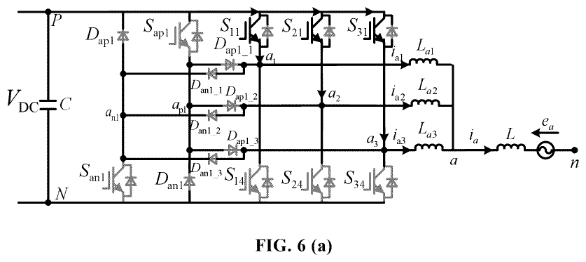

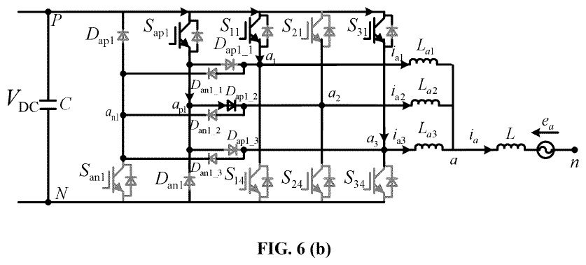

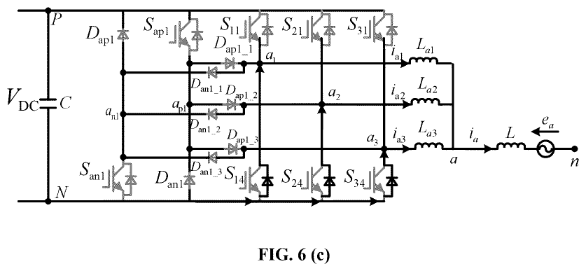

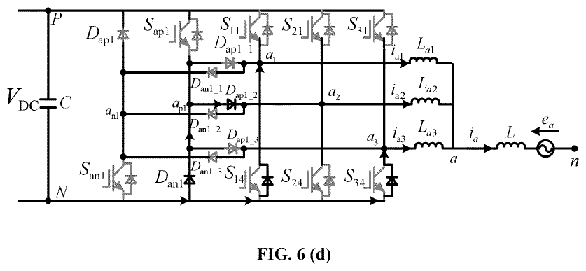

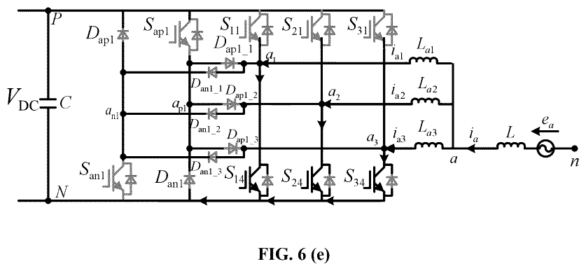

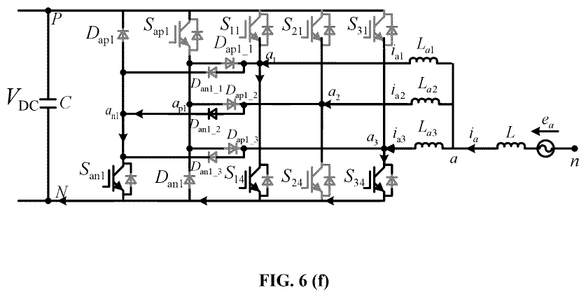

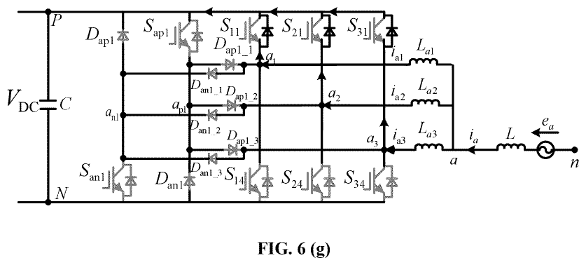

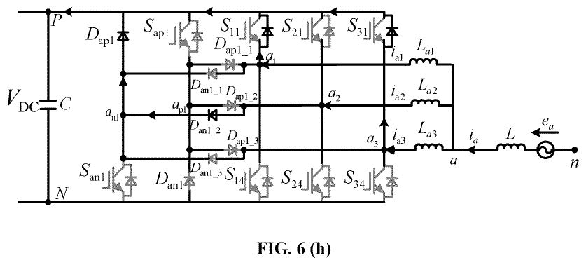

When an open-circuit fault occurs in a single device of the second branch in phase a of the converter, all branches in phase a are controlled with complete synchronization, and the possible current paths are shown in FIG. 6. The single device open-circuit fault in the second branch can be categorized into four types of faults: upper-arm IGBT fault, upper-arm diode fault, lower-arm IGBT fault, and lower-arm diode fault.

a) When an upper-arm IGBT fault occurs and the parallel current is positive, the topology adaptive reconfiguration results in two operating conditions shown in FIG. 6(b) and FIG. 6(c), where FIG. 6(b) corresponds to a high-level output and FIG. 6(c) corresponds to a low-level output. When the parallel current is negative, the topology adaptive reconfiguration results in two operating conditions shown in FIG. 6(e) and FIG. 6(g), where FIG. 6(g) corresponds to a high-level output and FIG. 6(e) corresponds to a low-level output.

b) When an upper-arm diode fault occurs and the parallel current is positive, the topology adaptive reconfiguration results in two operating conditions shown in FIG. 6(a) and FIG. 6(c), where FIG. 6(a) corresponds to a high-level output and FIG. 6(c) corresponds to a low-level output. When the parallel current is negative, the topology adaptive reconfiguration results in two operating conditions shown in FIG. 6(e) and FIG. 6(h), where FIG. 6(h) corresponds to a high-level output and FIG. 6(e) corresponds to a low-level output.

c) When a lower-arm IGBT fault occurs and the parallel current is positive, the topology adaptive reconfiguration results in two operating conditions shown in FIG. 6(a) and FIG. 6(c), where FIG. 6(a) corresponds to a high-level output and FIG. 6(c) corresponds to a low-level output. When the parallel current is negative, the topology adaptive reconfiguration results in two operating conditions shown in FIG. 6(f) and FIG. 6(g), where FIG. 6(g) corresponds to a high-level output and FIG. 6(f) corresponds to a low-level output.

d) When a lower-arm diode fault occurs and the parallel current is positive, the topology adaptive reconfiguration results in two operating conditions shown in FIG. 6(a) and FIG. 6(d), where FIG. 6(a) corresponds to a high-level output and FIG. 6(d) corresponds to a low-level output. When the current is negative, the topology adaptive reconfiguration results in two operating conditions shown in FIG. 6(e) and FIG. 6(g), where FIG. 6(g) corresponds to a high-level output and FIG. 6(e) corresponds to a low-level output.

The experimental conditions include a DC bus voltage of 400V, a switching frequency of 5 kHz, a load resistance of 10Ω, and a converter filter inductance of 10 mH.

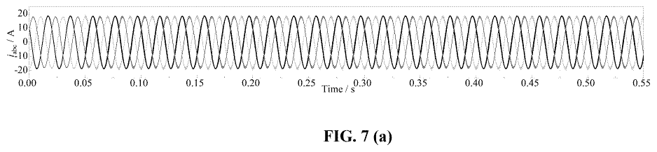

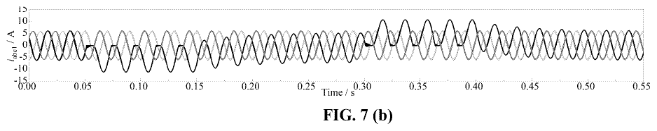

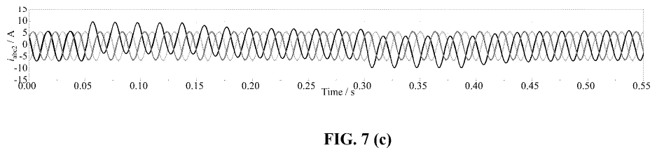

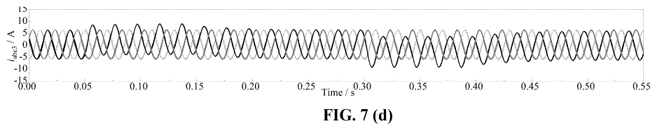

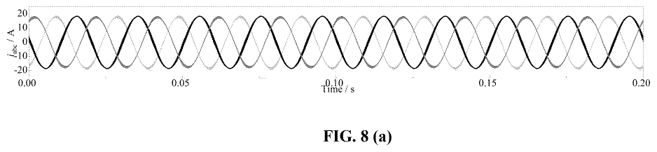

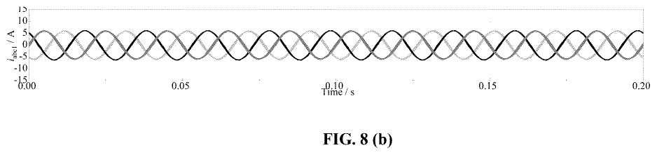

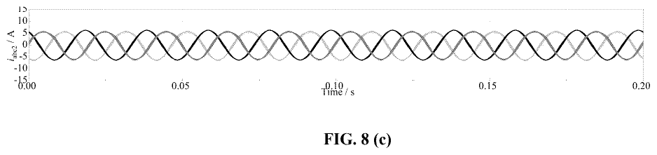

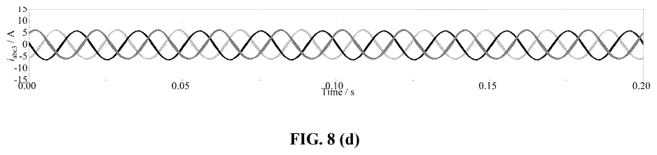

FIG. 7(a) to FIG. 7(d) and FIG. 8(a) to FIG. 8(d) show the experimental results of fault-tolerant operation obtained under a modulation index of 1.0. The experimental condition involves sequential open-circuit faults in the upper IGBT and lower IGBT of the first branch in phase b. FIG. 7 shows the dynamic process of fault-tolerant operation, recording the changes in parallel current and three-phase currents of the three parallel branches through five stages: from normal operation, to an open-circuit fault of the upper-arm IGBT in phase b, then to the activation of the upper-arm redundant unit, followed by an open-circuit fault in the lower-arm IGBT in phase b, and finally to the activation of the lower-arm redundant unit. Wherein, FIG. 7(a) shows the waveform of the parallel current, FIG. 7(b) shows the three-phase current waveform of the first parallel branch, FIG. 7(c) shows the three-phase current waveform of the second parallel branch, and FIG. 7(d) shows the three-phase current waveform of the third parallel branch. FIG. 8 shows the steady-state waveforms when fault-tolerant operation. FIG. 8(a) shows the waveform of the parallel current, FIG. 8(b) shows the three-phase current waveform of the first parallel branch, FIG. 8(c) shows the three-phase current waveform of the second parallel branch, and FIG. 8(d) shows the three-phase current waveform of the third parallel branch. The experimental results demonstrate that the proposed hardware redundancy scheme achieves fault-tolerant operation without additional control circuits. Moreover, in response to a wide variety of fault types, the proposed hardware redundancy scheme can adaptively reconfigure hardware resources through diodes. Additionally, by employing hardware reconfiguration, the topology minimizes the impact of open-circuit faults on the multi-parallel converter system, achieves fault-tolerant functionality and improves the reliability of the multi-parallel converter system.

The above description of embodiments enables those skilled in the art to make or use this disclosure. Various modifications to the above embodiments will be apparent to those skilled in the art, and the general principles defined herein may be applied to other embodiments without requiring inventive effort. Therefore, the disclosure is not limited to the embodiments shown herein, but is intended to encompass the broadest scope consistent with the principles and novel features disclosed herein.

What is claimed is:

1. An adaptive fault-tolerant topology for a three-phase multi-parallel converter based on redundant units, comprising a DC power supply, a three-phase AC power supply or a three-phase load resistor, three-phase filter inductors, and three-phase parallel branches, the parallel branches of each phase comprising n parallel bridge arms and n parallel filter inductors, wherein, each phase further comprises a redundant module including redundant units and redundant diodes, each redundant unit is a combination of IGBTs and diodes, the redundant unit is connected to an AC output side of the corresponding parallel bridge arms through a redundant diode; during normal operation, the redundant module is maintained in an off state and not connected to the parallel branch, when an open-circuit fault occurs in an IGBT or diode of the parallel bridge arm, the redundant unit is automatically connected to the faulty branch through the redundant diode, replacing faulty components in the faulty branch, allowing the multi-parallel converter to operate normally.

2. The adaptive fault-tolerant topology for a three-phase multi-parallel converter based on redundant units according to claim 1, wherein the control of the redundant module is specifically as follows:
during normal operation, the drive signal of the redundant module is maintained at a low level, and the redundant module is maintained in an off state and is not connected to the topology, the multi-parallel converter uses a normal operation control strategy to achieve system operation;
when a fault occurs, the drive signal of the redundant module connected in parallel with the faulty phase bridge arm is enabled, the redundant module is automatically connected to a hardware topology through the redundant diode, simultaneously, the drive signals of all parallel branches of the faulty bridge arm are synchronized with the signal of the redundant module to achieve fault-tolerant operation after the fault, the synchronization signal can be selected from the signal of any bridge arm in the parallel branch.

3. The adaptive fault-tolerant topology for a three-phase multi-parallel converter based on redundant units according to claim 1, wherein, the redundant module comprises an upper-arm redundant module and a lower-arm redundant module, the upper-arm redundant module is used for backup in case of upper-arm IGBT fault and lower-arm diode fault in the parallel bridge arm, and the lower-arm redundant module is used for backup in case of lower-arm IGBT fault and upper-arm diode fault in the parallel bridge arm.

4. The adaptive fault-tolerant topology for a three-phase multi-parallel converter based on redundant units according to claim 3, wherein, the upper-arm redundant module comprises p upper-arm redundant units and p_{z} upper-arm redundant diodes, and the lower-arm redundant module comprises q lower-arm redundant units and q_{z} lower-arm redundant diodes, the upper-arm redundant units and the lower-arm redundant units are connected in parallel with the parallel bridge arms, the emitters of the IGBTs in the upper-arm redundant units are connected to the AC output side of the parallel bridge arms through the upper-arm redundant diodes, and the collectors of the IGBTs in the lower-arm redundant units are connected to the AC output side of the parallel bridge arms through the lower-arm redundant diodes.

5. The adaptive fault-tolerant topology for a three-phase multi-parallel converter based on redundant units according to claim 4, wherein, for the p upper-arm redundant units, the emitter of the IGBT in the k-th upper-arm redundant unit is connected to the anodes of pₖ upper-arm redundant diodes, and their cathodes are connected to the AC output sides of pₖ different parallel bridge arms, thereby providing backup for faults in 1 to max(p,n) upper-arm IGBTs or lower-arm diodes in a single phase, where 1≤k≤p, 1≤pₖ≤n,
$${\sum }_{k = 1}^{p} {p}_{k} = {p}_{z} ,$$
with n parallel bridge arms, based on permutations and combinations, the number of redundant combination schemes is
$${\prod }_{k = 1}^{p} {C}_{n}^{{p}_{k}} .$$

6. The adaptive fault-tolerant topology for a three-phase multi-parallel converter based on redundant units according to claim 4, wherein, for the q lower-arm redundant units, the collector of the IGBT in the k-th lower-arm redundant unit is connected to the cathodes of qₖ lower-arm redundant diodes, and their anodes are connected to the AC output sides of qₖ different parallel bridge arms, thereby providing backup for faults in 1 to max(q,n) lower-arm IGBTs or upper-arm diodes in a single phase, where 1≤k≤q, 1≤q≤n,
$${\sum }_{k = 1}^{q} {q}_{k} = {q}_{z} ,$$
with n parallel bridge arms, based on permutations and combinations, the number of redundant combination schemes is
$${\prod }_{k = 1}^{q} {C}_{n}^{{q}_{k}} .$$

7. The adaptive fault-tolerant topology for a three-phase multi-parallel converter based on redundant units according to claim 4, wherein, when all upper-arm IGBTs in the n parallel bridge arms fail simultaneously, the number of upper-arm redundant units is set to p≥n, and the number p_{z} of upper-arm redundant diodes is in the range of [p,pₙ]; when all lower-arm IGBTs in the n parallel bridge arms fail simultaneously, the number of lower-arm redundant units is set to q≥n, and the number q_{z} of lower-arm redundant diodes is in the range of [q, qn].

8. The adaptive fault-tolerant topology for a three-phase multi-parallel converter based on redundant units according to claim 4, wherein, the upper-arm redundant unit comprises four structures, a first structure comprises only one IGBT, a second structure comprises one IGBT and one diode with the IGBT's emitter connected to the diode's anode and the IGBT's collector connected to the diode's cathode, a third structure comprises one IGBT and one diode connected in series with the IGBT's emitter connected to the diode's cathode, and a fourth structure comprises one IGBT and two diodes with an additional diode connected in series with the second structure and the IGBT's emitter connected to the cathode of the series-connected diode;
in the first and second structures, the IGBT's collector is either directly connected to the positive terminal of the DC power supply or indirectly connected through an impedance element, the IGBT's emitter is connected to the anode of the upper-arm redundant diode, and the cathode of the upper-arm redundant diode is connected to the AC output side of the parallel bridge arm for achieving topology adaptive reconfiguration after an open-circuit fault in the upper-arm IGBT of the parallel bridge arm; in the third and fourth structures, the IGBT's collector is either directly connected to the positive terminal of the DC power supply or indirectly connected through the impedance element, the IGBT's emitter is connected to the anode of the upper-arm redundant diode, the cathode of the upper-arm redundant diode is connected to the AC output side of the parallel bridge arm, and the anode of the series-connected diode is connected to the negative terminal of the DC power supply for achieving topology adaptive reconfiguration after occurring open-circuit faults in both the upper-arm IGBT and lower-arm diode of the parallel bridge arm;
the impedance element comprises a resistor or an inductor.

9. The adaptive fault-tolerant topology for a three-phase multi-parallel converter based on redundant units according to claim 4, wherein, the lower-arm redundant unit comprises four structures, a first structure comprises one IGBT, a second structure comprises one IGBT and one diode with the IGBT's emitter connected to the diode's anode and the IGBT's collector connected to the diode's cathode, a third structure comprises one IGBT and one diode connected in series with the IGBT's collector connected to the diode's anode, and a fourth structure comprises one IGBT and two diodes with an additional diode connected in series to the second structure and the IGBT's collector connected to the anode of the series-connected diode;
in the first and second structures, the IGBT's emitter is either directly connected to the negative terminal of the DC power supply or indirectly connected through an impedance element, the IGBT's collector is connected to the cathode of the lower-arm redundant diode, and the anode of the lower-arm redundant diode is connected to the AC output side of the parallel bridge arm for achieving topology adaptive reconfiguration after an open-circuit fault occurs in the lower-arm IGBT of the parallel bridge arm; in the third and fourth structures, the IGBT's emitter is either directly connected to the negative terminal of the DC power supply or indirectly connected through a low-impedance element, the IGBT's collector is connected to the cathode of the lower-arm redundant diode, the anode of the lower-arm redundant diode is connected to the AC output side of the parallel bridge arm, and the cathode of the series-connected diode is connected to the positive terminal of the DC power supply for achieving topology adaptive reconfiguration after open-circuit faults occur in both the lower-arm IGBT and upper-arm diode of the parallel bridge arm;
the impedance element comprises a resistor or an inductor.

10. The adaptive fault-tolerant topology for a three-phase multi-parallel converter based on redundant units according to claim 9, wherein, the control of the redundant module is specifically as follows:
when an open-circuit fault occurs in the upper-arm IGBT of the k-th parallel branch in phase x, the upper-arm redundant unit connected in parallel with the k-th branch is activated, and the emitter of the IGBT in the upper-arm redundant unit is automatically connected to the parallel topology through the upper-arm redundant diode, thereby replacing the upper-arm IGBT in the faulty branch and achieving reconfiguration of a hardware topology;
when an open-circuit fault occurs in the upper-arm diode of the k-th parallel branch in phase x, the current that originally passes through the faulty diode flows through the lower-arm redundant diode into the series-connected diode of the lower-arm redundant unit connected in parallel with the faulty bridge arm, thereby achieving reconfiguration of the hardware topology;
when an open-circuit fault occurs in the lower-arm IGBT of the k-th parallel branch in phase x, the lower-arm redundant unit connected in parallel with the k-th branch is activated, and the collector of the IGBT in the lower-arm redundant unit is automatically connected to the parallel topology through the lower-arm redundant diode, thereby replacing the lower-arm IGBT in the faulty branch and achieving reconfiguration of the hardware topology;
when an open-circuit fault occurs in the lower-arm diode of the k-th parallel branch in phase x, the current that originally passes through the faulty diode flows through the upper-arm redundant diode into the series-connected diode of the upper-arm redundant unit connected in parallel with the faulty bridge arm, thereby achieving reconfiguration of the hardware topology.

11. The adaptive fault-tolerant topology for a three-phase multi-parallel converter based on redundant units according to claim 2, wherein, the redundant module comprises an upper-arm redundant module and a lower-arm redundant module, the upper-arm redundant module is used for backup in case of upper-arm IGBT fault and lower-arm diode fault in the parallel bridge arm, and the lower-arm redundant module is used for backup in case of lower-arm IGBT fault and upper-arm diode fault in the parallel bridge arm.
